(19) United States
(12) Patent Application Publication
(10) Pub. No.: US 2022/0154531 A1
(43) Pub. Date: May 19, 2022

(54) SYSTEM FOR SECURING AN UPRIGHT LADDER

(71) Applicant: SAFE N STRONG PTY LTD, Queensland (AU)

(72) Inventor: Justin Templeman, Queensland (AU)

(21) Appl. No.: 17/438,369

(22) PCT Filed: Mar. 12, 2020
(86) PCT No.: PCT/AU2020/050227

§ 371 Date: Sep. 10, 2021

(30) Foreign Application Priority Data
Mar. 13, 2019 (AU) 2019900830

(51) Int. Cl. E06C 1/34; E06C 1/12; E06C 7/06; E06C 7/18

(52) U.S. Cl. CPC E06C 1/34; E06C 7/186; E06C 7/06; E06C 1/12

(57) ABSTRACT

A system for securing an upright ladder provides a robust and reliable mechanism for securing the ladder to a vertical object such as a pole or tree. The system comprises: a pole bracket positioned adjacent a top distal end of the ladder between a first rail and a second rail of the ladder; an upper anchor mechanism positioned on or adjacent the first rail; an upper ratchet cleat mechanism positioned on or adjacent the second rail; and an eyelet/guider positioned adjacent the upper ratchet cleat mechanism for guiding, in use, a rope into the upper ratchet cleat mechanism; wherein the upper anchor mechanism and the upper ratchet cleat mechanism are positioned at approximately a same longitudinal distance from the top distal end of the ladder.

### BACKGROUND TO THE INVENTION

The high risks and dangers of injury or death caused when people fall from ladders are well documented. Safework Australia reported that in the twelve years from 1 Jan. 2003 to 31 Dec. 2015, 54 workers died in Australia following a fall from a ladder. In the united states, the Center for Disease Control and Prevention reported that falls remain a leading cause of unintentional injury mortality nationwide and report that approximately 300 people die from ladder related injuries per year in the United States. Among workers, approximately 20% of fall injuries treated in U.S. emergency departments (EDs) involve a ladder.

Falls from ladders are particularly likely when a ladder is not properly erected. Also, the use of ladders for climbing poles and trees can add additional risk, as the top rung of the ladder generally rests against a single point on the pole or tree. The top of the ladder can thus easily pivot about the pole or tree and initiate a fall of the user.

Various prior art devices have been conceived to secure the tops of ladders to poles or trees to reduce the risk of falls. For example, numerous patents have been granted for different types of ladder designs that include grasping mechanisms at the top of the ladder for grabbing a pole or tree, and are intended to reduce the risk that a ladder will unintentionally slip or pivot about the pole or tree after the ladder has been erected.

However, the prior art devices suffer from numerous deficiencies, including excessive complexity, unreliable locking mechanisms, low strength, excessive weight, and difficulty of operation.

There is therefore a need for an improved system for securing an upright ladder against a pole or tree.

### OBJECT OF THE INVENTION

It is an object of the present invention to overcome and /or alleviate one or more of the disadvantages of the prior art or provide the consumer with a useful or commercial choice.

### SUMMARY OF THE INVENTION

According to one aspect, the invention is a system for securing an upright ladder, comprising:

a pole bracket positioned adjacent a top distal end of the ladder between a first rail and a second rail of the ladder;

an upper anchor mechanism positioned on or adjacent the first rail;

an upper ratchet cleat mechanism positioned on or adjacent the second rail; and

an eyelet/guider positioned adjacent the upper ratchet cleat mechanism for guiding, in use, a rope into the upper ratchet cleat mechanism;

wherein the upper anchor mechanism and the upper ratchet cleat mechanism are positioned at approximately a same longitudinal distance from the top distal end of the ladder.

Preferably, the system further comprises:

a lower anchor mechanism positioned on or adjacent the first rail; and

a lower ratchet cleat mechanism positioned on or adjacent the second rail;

wherein the lower anchor mechanism and the lower cleat mechanism are positioned at approximately a same longitudinal distance from the top distal end of the ladder.

Preferably, a rope having a first end is secured to the upper (or lower) anchor mechanism, wherein the rope extends around a vertical object and is locked into the upper (or lower) ratchet cleat mechanism, thus securing the pole bracket against the vertical object.

Preferably, the upper (or lower) anchor mechanism comprises an eyelet for securing a carabiner.

Preferably, the upper (or lower) ratchet cleat mechanism is a cam cleat comprising a pair of rotatable cams.

Preferably, the eyelet/guider positioned adjacent the upper ratchet cleat mechanism is located approximately 35 mm to 150 mm from a centre point between the rotatable cams.

Preferably, the upper (or lower) anchor mechanism and the cleat mechanism are secured to a rung of the ladder.

Preferably, the upper (or lower) anchor mechanism is secured to the first rail and the upper (or lower) ratchet cleat mechanism is secured to the second rail.

Preferably, the upper (or lower) anchor mechanism and the upper (or lower) ratchet cleat mechanism are each retrofittably secured to the ladder using a U-bolt or brackets or straps or clamps.

Preferably, the ladder comprises an extension ladder, and the upper anchor and cleat mechanisms are secured to an upper extension member of the ladder and the lower anchor and cleat mechanisms are secured to a lower base member of the ladder.

In another form, although not necessarily the only or the broadest form, the invention resides in a kit for assembling the system of claim 1, the kit comprising:

the upper anchor mechanism as defined above;

the upper ratchet cleat mechanism; and

bolts for connecting the upper anchor mechanism and the upper ratchet cleat mechanism to a ladder.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 is a rear perspective view of a system for securing an upright ladder, including a demonstration of a user setting up an upper securing system;

FIG. 2 is a front perspective view of the system of FIG. 1;

FIG. 3 is a front perspective view of an upper securing system of the system of FIG. 1;

FIG. 4 is a top view of the upper securing system of the system of FIG. 1;

FIG. 5 is a front view of the upper securing system of the system of FIG. 1;

FIG. 6 is a front perspective view of a lower securing system of the system of FIG. 1;

FIG. 7 is a top view of the lower securing system of the system of FIG. 1; and

FIG. 8 is a front view of the lower securing system of the system of FIG. 1.

### DETAILED DESCRIPTION OF THE DRAWINGS

The present invention relates to a system for securing an upright ladder. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, top and bottom, upper and lower, rear, front and side, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the present invention is defined as a system for securing an upright ladder, comprising: a pole bracket positioned adjacent a top distal end of the ladder between a first rail and a second rail of the ladder; an upper anchor mechanism positioned on or adjacent the first rail; an upper ratchet cleat mechanism positioned on or adjacent the second rail; and an eyelet/guider positioned adjacent the upper ratchet cleat mechanism for guiding, in use, a rope into the upper ratchet cleat mechanism, wherein the upper anchor mechanism and the upper ratchet cleat mechanism are positioned at approximately a same longitudinal distance from the top distal end of the ladder.

Advantages of some embodiments of the present invention include providing a robust and reliable mechanism for securing a ladder to a vertical object such as a pole or tree. The ratchet cleat mechanism allows a secure locking of a rope when tightened around the vertical object by a user still standing on the ground. Further, a free end of the same rope used to secure the top of the ladder to the pole or tree can be also used simultaneously to secure a harness of the user. Also, a similar ratchet cleat mechanism can be used to also secure a lower end of the ladder to the pole or tree. Finally, the ladder then can be easily released from the secured position against the pole or tree after the user is again safely on the ground.

Still other advantages provided by the invention include a simple and retrofittable system, which can be used to secure a ladder quickly.

Those skilled in the art will appreciate that all of the above advantages are not necessarily provided by all embodiments of the present invention.

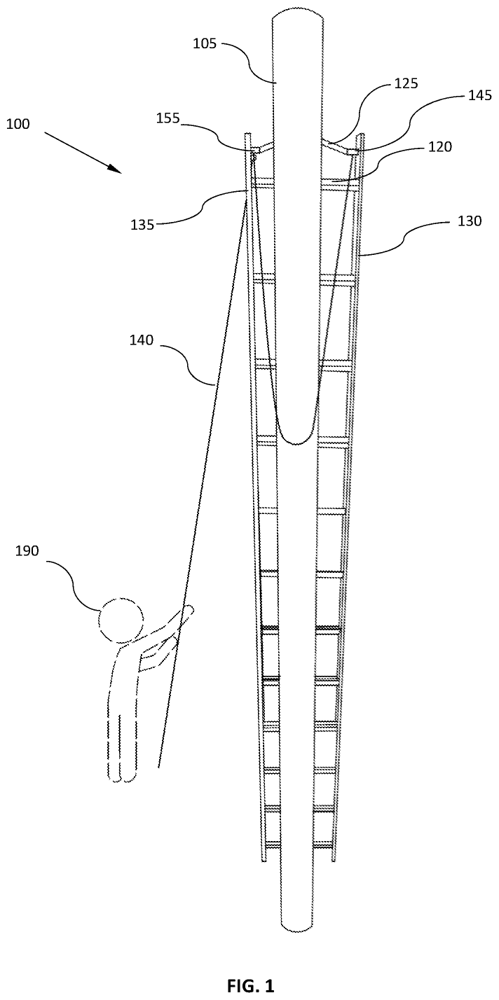

FIG. 1 is a rear perspective view of a system for securing an upright ladder 100, including a demonstration of a user 190 setting up an upper securing system. The system includes a pole bracket 125 positioned adjacent a top distal end of the ladder 100, between a first rail 130 and a second rail 135 of the ladder 100. An upper anchor mechanism 145 is positioned on or adjacent the first rail 130, and an upper ratchet cleat mechanism 155 positioned on or adjacent the second rail 135.

Before the ladder 100 is raised into the upright position, the user 190 locates a first end of a first rope 140 which is secured to the upper anchor mechanism 145. The user 190 then positions the first rope 140 around the rear of a pole 105 and locks the first rope 140 into the upper ratchet cleat mechanism 155.

The user 190 can then erect the ladder 100 against the pole 105 while the rope 140 hangs loosely around the pole 105, and thus the rope 140 does not hinder erection of the ladder 100. After the ladder 100 is erected the user pulls the first rope 140 through the upper ratchet cleat mechanism 155, which secures the rope 140 around the pole 105 and behind the pole bracket 125, thus securing the ladder 100 to the pole 105.

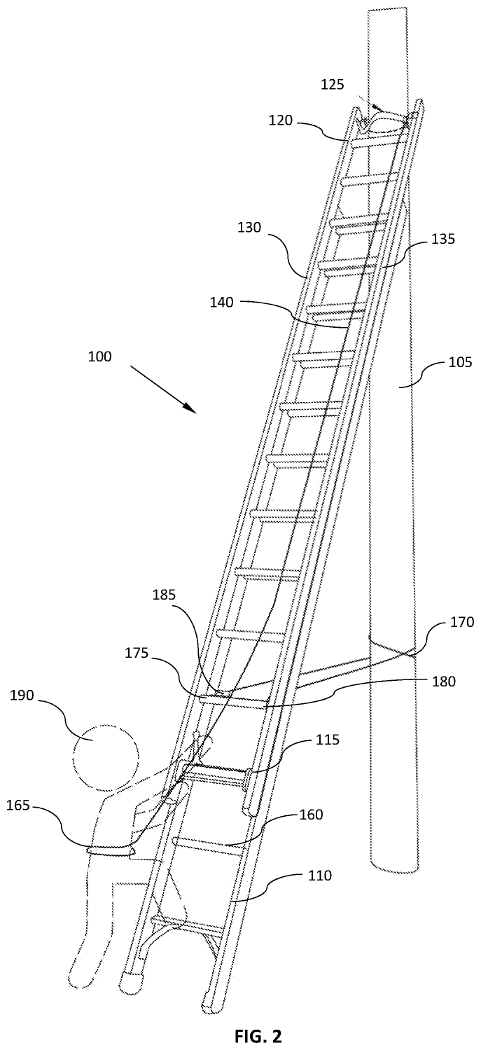

FIG. 2 is a front perspective view of the system of FIG. 1. The ladder 100 includes a base member 110 and a first extension member 115, which are slidingly engaged to enable a maximum height of the ladder 100 to be increased, as is well known in the field of extension ladders. As shown, the pole bracket 125 is positioned above a top rung 120 of the first extension member 115, between the first rail 130 and the second rail 135 of the ladder 100. The pole bracket 125 generally includes a curved middle section to conform to the shape of a pole or tree, and may also include a rubber grip (not illustrated), to provide more secure contact with the pole 105.

Further, the upper anchor mechanism 145 and the upper ratchet cleat mechanism 155 are positioned at approximately a same longitudinal distance from the top distal end of the ladder 100, such as on either side of the pole bracket 125, on the first and second rails 130, 135, or on either side of the top rung 120 of the ladder 100. A longitudinal distance along the ladder 100 is measured along or parallel to one of the first or second rails 130, 135.

The first rope 140 extends from the upper ratchet cleat mechanism 155 to the user 190 at the base of the ladder 100. The user 190 may secure the first rope 140 to a base rung 160 or, preferably, the first rope 140 is connected to a harness worn by the user 190. Then, as the user climbs up the ladder 100, slack in the rope 140 can be threaded through a cleat mechanism on the harness (not shown), such that if the user 190 falls from the ladder 100 his or her fall will be arrested by the rope 140 fixed to the upper anchor mechanism 145 and the upper ratchet cleat mechanism 155.

The ladder 100 further comprises a lower anchor mechanism 180 positioned on or adjacent the first rail 130, and a lower ratchet cleat mechanism 185 positioned on or adjacent the second rail 135. The lower anchor mechanism 180 and the lower ratchet cleat mechanism 185 are also positioned at approximately a same longitudinal distance from the top distal end of the ladder 100, such as on a rung of the ladder 100.

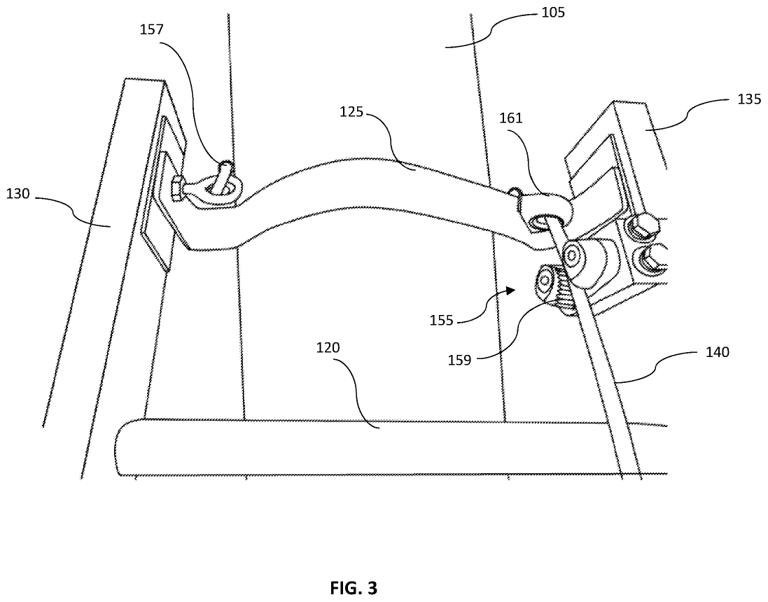

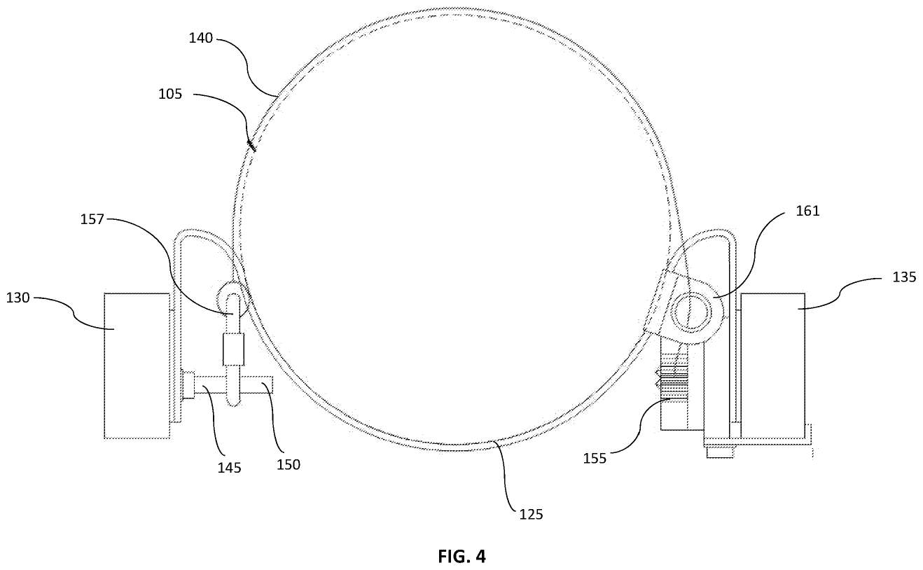

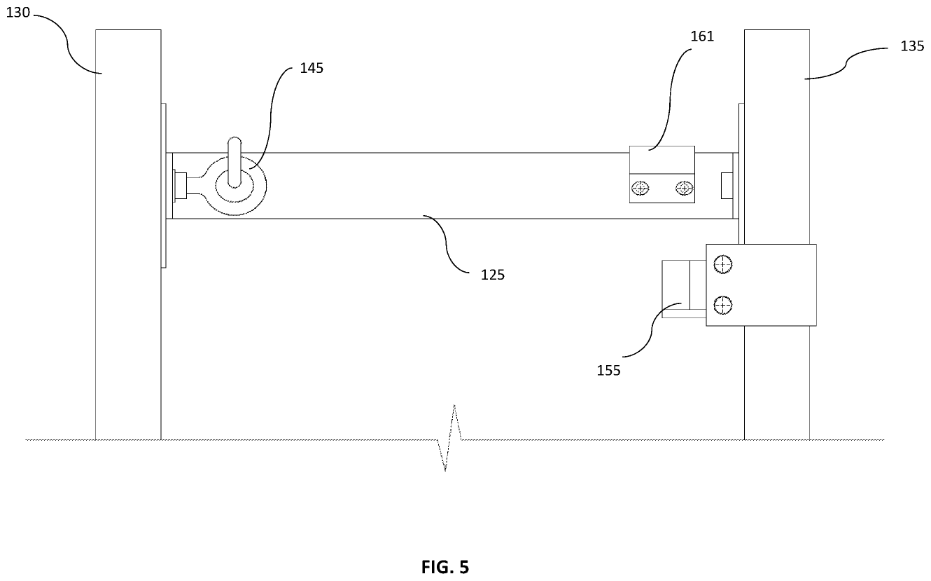

FIG. 3, FIG. 4 and FIG. 5 are a front perspective view, top view and front view, respectively, of an upper securing system of the system of FIG. 2.

The upper anchor mechanism 145 comprises an eyebolt 150 for securing a carabiner 157. The first rope 140 is secured to the carabiner 157, extends around the pole 105, and is then locked into the upper ratchet cleat mechanism 155, thus securing the pole bracket 125 against the pole 105. As shown, the upper ratchet cleat mechanism 155 is a cam cleat comprising a pair of rotatable cams 159. An eyelet /guider 161 is adjacent the pair of rotatable cams 159 and is used to guide the first rope 140 into the rotatable cams 159.

According to some embodiments, a distance from the eyelet/guider 161 to a centre point between the rotatable cams 159, where the cams 159 bite into the rope 140, is generally about 35 mm to 150 mm. After the ladder 100 is erected against the pole 105, the positioning of the eyelet/guider 161 enables a person standing on the ground to easily guide the first rope 140 into the rotatable cams 159 so as to secure the pole bracket 125 against the pole 105.

Also, according to some alternative embodiments the eyelet/guider 161 is connected to a bracket (not shown) extending from a base plate of the upper ratchet cleat mechanism 155, such that the eyelet/guider 161 and rotatable cams 159 form part of an integral component.

Further, as shown in FIG. 3, the orientation of the rotatable cams 159 is such that they rotate about an axis approximately perpendicular to the longitudinal axis of the ladder 100. That enables the rope 140 to be easily and conveniently removed from the upper ratchet cleat mechanism 155 after the user 190 has climbed back down the ladder 100 and is again safely on the ground. The user 190 then simply tugs the rope 140 downward and to the side (i.e., to the left in FIG. 3) and the rope 140 will easily slide out of the rotatable cams 159 and free of the ratchet cleat mechanism 155. The ladder 100 then can be safely lowered down from the pole 105.

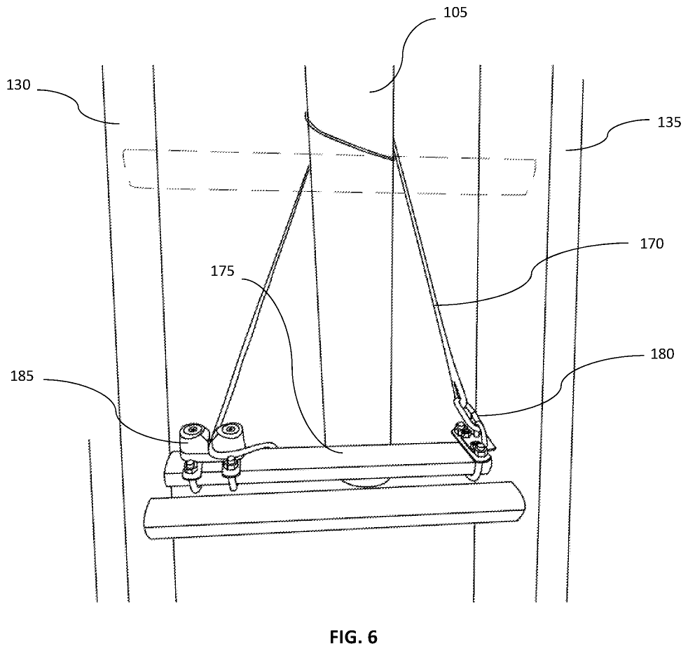

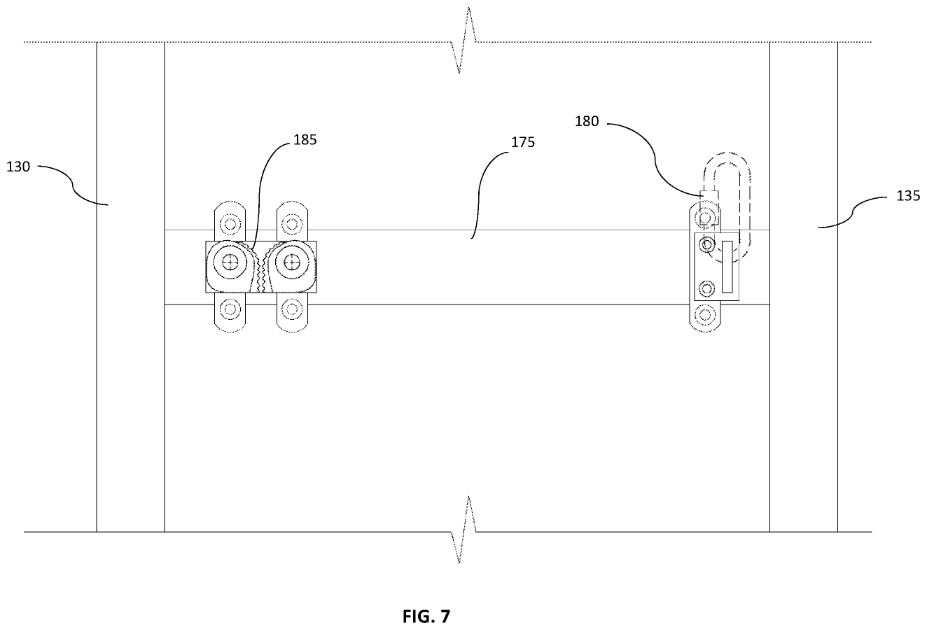

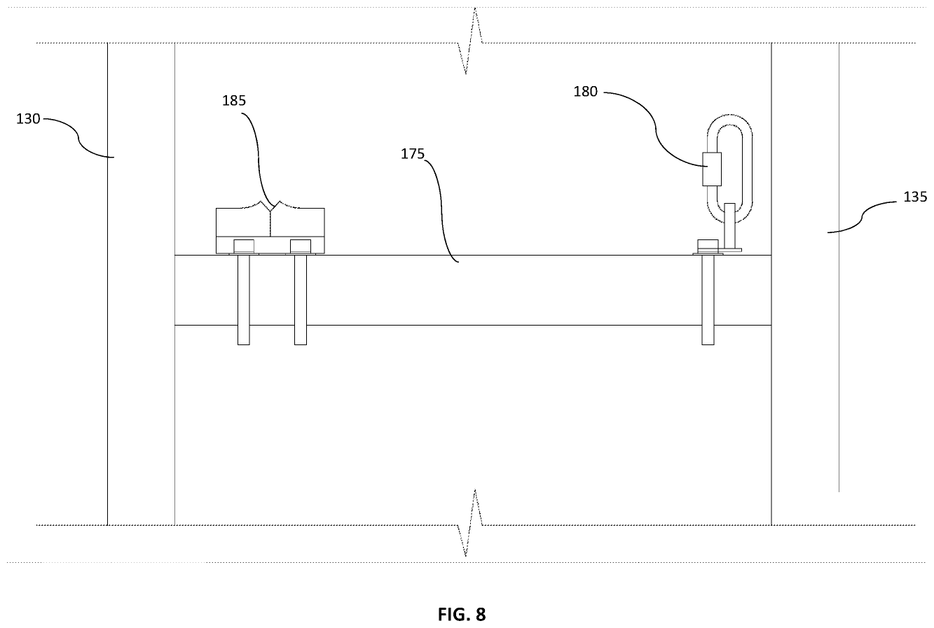

A second means of securing the ladder 100 to the pole 105 is also illustrated in FIG. 2, wherein a second rope 170 is attached to a lower rung 175 of the first extension member 115. FIG. 6, FIG. 7 and FIG. 8 demonstrate a front perspective view, a top view, and a front view, respectively, of a lower securing system of the system of FIG. 1. The second rope 170 is connected to the lower rung 175 using a lower anchor mechanism 180 positioned on or adjacent the second rail 135. Once the ladder 100 is erected and the pole bracket 125 is secured, the user 190 locates a first end of the second rope 170 and secures it to the lower anchor mechanism 180. The user 190 then positions the second rope 170 around the rear of the pole 105 and locks the second rope 170 into the lower ratchet cleat mechanism 185.

The lower ratchet cleat mechanism 185 is positioned on or adjacent the first rail 130 on or near the lower rung 175. The lower anchor mechanism 180 and the lower ratchet cleat mechanism 185 are also positioned at approximately a same longitudinal distance from the distal end of the ladder 100.

The lower anchor mechanism 180 also comprises an eyelet/guider for securing a carabiner. Further, the lower ratchet cleat mechanism 185 is also a cam cleat comprising a pair of rotatable cams. However, those skilled in the art will appreciate that various types of alternative ratchet cleat mechanisms also can be used, such as those used with various types of rope and climbing gear.

The upper and lower anchor mechanisms 145, 180 and the upper and lower ratchet cleat mechanisms 155, 185 can be retrofittably secured to the ladder 100 using U-bolts. For example, the U-bolts can extend around a rung of the ladder 100 or around the side rails 130, 135 of the ladder 100. That enables the mechanisms 145, 155, 180, 185 to be very securely and yet very easily attached to the ladder 100 using basic tools such as a wrench and socket set.

Those skilled in the art will appreciate that various embodiments of the present invention can be made of various materials, or a combination of various materials, including aluminium, steel, metal alloys, or high strength plastics or composites. Those skilled in the art will further appreciate that the invention is not limited to the use of a rope to secure the ladder, as the ladder may be secured using various other materials including cables or straps.

The above description of various embodiments of present invention is provided for purposes of description to one of ordinary skill in the related art. It is not intended to be exhaustive or to limit the invention to a single disclosed embodiment. Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A system for securing an upright ladder, comprising:
a pole bracket positioned adjacent a top distal end of the ladder between a first rail and a second rail of the ladder;
an upper anchor mechanism positioned on or adjacent the first rail;
an upper ratchet cleat mechanism positioned on or adjacent the second rail; and
an eyelet/guider positioned adjacent the upper ratchet cleat mechanism for guiding, in use, a rope into the upper ratchet cleat mechanism;
wherein the upper anchor mechanism and the upper ratchet cleat mechanism are positioned at approximately a same longitudinal distance from the top distal end of the ladder.

2. The system of claim 1, further comprising:
a lower anchor mechanism positioned on or adjacent the first rail; and
a lower ratchet cleat mechanism positioned on or adjacent the second rail;
wherein the lower anchor mechanism and the lower cleat mechanism are positioned at approximately a same longitudinal distance from the top distal end of the ladder.

3. The system of claim 1, further comprising a first rope having a first end secured to the upper anchor mechanism, wherein the rope extends around a vertical object and is locked into the upper ratchet cleat mechanism, thus securing the pole bracket against the vertical object.

4. The system of claim 1, wherein the upper anchor mechanism comprises an eyelet for securing a carabiner.

5. The system of claim 1, wherein the upper ratchet cleat mechanism is a cam cleat comprising a pair of rotatable cams.

6. The system of claim 5, wherein the eyelet/guider positioned adjacent the upper ratchet cleat mechanism is located approximately 35 mm to 150 mm from a centre point between the rotatable cams.

7. The system of claim 1, wherein the upper anchor mechanism and the upper cleat mechanism are secured to a rung of the ladder.

8. The system of claim 1, wherein the upper anchor mechanism is secured to the first rail and the upper ratchet cleat mechanism is secured to the second rail.

9. The system of claim 1, wherein the upper anchor mechanism and the upper ratchet cleat mechanism are each retrofittably secured to the ladder using a U-bolt or brackets or straps or clamps.

10. The system of claim 2, wherein the ladder comprises an extension ladder, and the upper anchor and cleat mechanisms are secured to an upper extension member of the ladder, and the lower anchor and cleat mechanisms are secured to a lower base member of the ladder.

11. The system of claim 2, further comprising a second rope having a first end secured to the lower anchor mechanism, wherein the second rope extends around a vertical object and is locked into the lower ratchet cleat mechanism, thus further securing the ladder to the vertical object.

12. The system of claim 2, wherein the lower anchor mechanism comprises an eyelet for securing a carabiner.

13. The system of claim 2, wherein the lower ratchet cleat mechanism is a cam cleat comprising a pair of rotatable cams.

14. The system of claim 13, wherein the lower cam cleat comprises an eyelet adjacent the pair of rotatable cams.

16. The system of claim 2, wherein the lower anchor mechanism and the lower cleat mechanism are secured to a lower rung of the ladder.

17. The system of claim 2, wherein the lower anchor mechanism is secured to the first rail and the lower ratchet cleat mechanism is secured to the second rail.

18. The system of claim 2, wherein the lower anchor mechanism and the lower ratchet cleat mechanism are each retrofittably secured to the ladder using a U-bolt/brackets/straps/ or clamps.

19. A kit for assembling the system of claim 1, the kit comprising:
the upper anchor mechanism;
the upper ratchet cleat mechanism; and
bolts for connecting the upper anchor mechanism and the upper ratchet cleat mechanism to a ladder.

20. A kit for assembling the system of claim 2, the kit comprising:
the upper and lower anchor mechanism;
the upper and lower ratchet cleat mechanism; and
bolts for connecting the upper and lower anchor mechanism and the upper and lower ratchet cleat mechanism to a ladder.
